(19) United States
(12) Patent Application Publication
(10) Pub. No.: US 2008/0270186 A1
(43) Pub. Date: Oct. 30, 2008

(54) Giving a Service to a Patient

(76) Inventors: Soren Mikkelsen, Ballerup (DK); Andre Larsen, Dragor (DK)

Correspondence Address: NOVO NORDISK, INC.;INTELLECTUAL PROPERTY DEPARTMENT, 100 COLLEGE ROAD WEST, PRINCETON, NJ, 08540, US

(21) Appl. No.: 11/661,018

(22) PCT Filed: Aug. 24, 2005
(86) PCT No.: PCT/EP05/54154

§ 371 Date: Jul. 15, 2008

(30) Foreign Application Priority Data
Aug. 24, 2004 (DK) PA 2004 01276

(51) Int. Cl. G06Q 50/00; G06F 19/00; G06Q 10/00; G06Q 30/00

(52) U.S. Cl. 705/3

(57) ABSTRACT

This invention relates to a method comprising the steps of: subscribing with an identification code of a drug administration device to a health care advisory system, transferring the identification code of the drug administration device to the health care advisory system, controlling that the patient having the drug administration device is a subscriber to the health care advisory system based on the received identification code, requesting and receiving treatment data from the subscribing drug administration device, generating an advice based on the received treatment data and a personalized setup of patient related data in the health care advisory system, and/or generating an order based on the received treatment data in the health care advisory system to supply goods to the patient, and sending the advice to the drug administration device, and/or sending the order to a goods supplier, said method further comprises the step of charging the patient having the drug administration device for the received service.

The present invention relates to a method of giving a service to a patient. Further, the invention relates to a drug administration device on which said method can be carried out.

The present invention also relates to a system comprising a health care advisory system and said drug administration device.

The present invention further relates to a computer program product for performing the method.

In the art various devices are known to provide a diabetic patient aiding in treatment of diabetes, e.g. U.S. Pat. No. 6,656,114 which discloses a method of self treating diabetes. The method includes collecting in one or more databases data representing values of parameters that related to the self treatment. The data is processed to provide a plurality of alternate choices between two or more actions that may be taken and a corresponding value for each action is calculated.

Typically, such a device (e.g. a doser, a syringe with or without computer control and display functions) will require the user to collect a lot of data about his treatment of diabetes in order to be able to perform for a subsequent analysis of data. Such data will be glucose levels with time stamps, amount of insulin, which concentration and when taken. Often data regarding exercises performed, food and beverages consumed along with their corresponding time stamps also are comprised in data indicating how the treatment of diabetes is/was handled. An analysis of these data, performed by a suitable programmed software tool, can provide an insight in whether the patient is maltreated or treated well with respect of diabetes, and eventually an advice is given. However, such a computer generated “insight” and the subsequent advice are not modified or are not confirmed by a physician to be valid, i.e. the patient cannot be sure that the advice to be followed will improve his treatment.

Further more, the patient will need a blood glucose meter to measure his glucose concentration. The glucose concentration can by itself provide a quick and simple insight on the spot in whether the patient is maltreated or treated well but only for this single glucose measurement.

Instruments for measuring blood glucose are known in the prior art which have a so-called diary function. An example of such an instrument is the Accutrend DM from the Boehringer Mannheim Company. A diabetic can use this instrument to determine and store his blood glucose concentrations.

The time course of the measured blood glucose values shows the patient whether his insulin therapy is suitable. The aim of the treatment is to keep the blood glucose in a normal range which is approximately between 80 and 180 mg/dl. If the blood sugar level decreases below a value of 50 mg/dl this is referred to as hypoglycaemia which is dangerous for the patient since it impairs his cognitive powers and he may even fall into a so-called hypoglycaemic shock which can lead to death.

In contrast blood sugar values above 250 mg/dl are undesired since they can lead to longterm side effects such as diabetic feet or loss of sight. New types of treatment all aim to help the patient to dose meals, insulin or physical activities according to needs. However, in order to carry them out successfully the diabetic must learn strategies for insulin treatment, but in some unusual instances it is dangerous, i.e. harmful to the health of the patient, to leave the treatment decision to a device or to the patient him-self.

As a prerequisite and as a background for understanding the invention, a diabetic patient has the following actions during a day:

6:30—alarm-clock, the patient awakens
6:35—injection or inhalation of short acting insulin

These data is to be collected and automatically stored in the drug administration device for later use, i.e. as the amount of insulin and the type of insulin (e.g. concentration).

6:40—shower
6:50—breakfast

This meal or food related data is to be collected and automatically stored in the drug administration device for later use, e.g. as the amount of carbohydrates corresponding to the breakfast.

7:15—off to work
9:30—snack at a meeting

The snack related data is to be collected and automatically stored in the drug administration device for later use, e.g. as the amount of carbohydrates corresponding to the meeting snack.

11:45—blood glucose testing

When the patient tests his BG, i.e. blood glucose reading, These data is to be collected and automatically stored in the drug administration device for later use, even though these data may come from an external glucose meter.

11:47—injection or inhalation of short acting insulin

These data is again to be automatically stored, i.e. as the amount of insulin and the type of insulin.

12:15—lunch

This lunch related data is to be collected and automatically stored in the drug administration device for later use, e.g. as the amount of carbohydrates corresponding to this lunch intake.

14:50—blood glucose testing

These data is to be collected and then entered to the drug administration device, even though these data may come from an external glucose meter.

15:00—afternoon snack—fruit

The related data to the fruit consumed is to be collected and automatically stored in the drug administration device for later use, e.g. as the amount of carbohydrates corresponding to the afternoon snack.

15:10—blood glucose testing

This glucose data is to be collected and to be entered to the drug administration device.

15:15—short acting insulin

These data is automatically or manually stored, i.e. as the amount of insulin and the type of insulin to the drug administration device.

16:00—off from work
16:20—exercise in fitness club

Exercise related data is to be stored, e.g. as the kind of exercise and its duration to the drug administration device.

17:25—blood glucose testing

This information, i.e. the blood glucose level may be automatically stored or manually entered to the drug administration device.

17:30—fruit

The data related to this particular fruit is to be collected and automatically stored in the drug administration device for later use, e.g. as the amount of carbohydrates corresponding to the fruit.

18:30—blood glucose testing

The blood glucose level may be automatically stored or manually entered to the drug administration device.

8:35—injection or inhalation of short acting insulin

Again, these data is automatically or manually stored, i.e. as the amount of insulin and the type of insulin (short acting) to the drug administration device.

19:00—supper

This data (e.g. amount of carbohydrates) as food intake is automatically or manually stored to the drug administration device.

20:30—coffee

This data (e.g. amount of carbohydrates) as beverage is automatically or manually stored to the drug administration device.

23:30—blood glucose testing

This blood glucose level may be automatically stored or manually entered to the drug administration device.

23:35—injection or inhalation of long acting insulin before the night

Finally, these data is automatically or manually stored, i.e. as the amount of insulin and the type of insulin (long acting) to the drug administration device.

For both glucose values and insulin taken the corresponding time stamps (year, month, day, hour and minute) are to be stored with these data points. Additionally, the same applies for exercises and meals or other intake of food and beverages.

All these data, denoted “treatment data” are thus stored within the drug administration device. Thus, blood glucose data, insulin intakes, meal and exercise, respectively with their time stamps are in the memory of the drug administration device. Often these data are referred to diary data belonging to the diary function as was discussed above.

The systems known in the prior art already enable a patient to observe to a certain extent what influence food intake, physical activities (i.e. exercise) and insulin administration has on his blood sugar level.

However, in order to carry the administration of food intake, physical activities and insulin administration out successfully the diabetic must learn strategies for insulin treatment, but in some unusual instances it is dangerous, i.e. harmful to the health of the patient, to leave the treatment decision to a device or to the patient himself, i.e. without a physician having been involved in the generation of the advice or at least had to confirm the advice, typical in a situation where the advice could have a significant impact of the outcome of the treatment.

As an example, there may be an unusual situation which will be reflected in an unusual pattern of the treatment data. It is a disadvantage, that such an unusual situation cannot be handled by the patient himself or by a stand alone device as known in the art.

Furthermore, if the patient is away from his hospital and/or is remote to the nurse, the physician, the healthcare persons, it is very difficult for him to get a proper advice, especially when faced with an unusual situation.

Further it is a problem for the patient if he runs out of his aiding items for the treatment of his diabetes; the aiding items are insulin cartridges of different concentrations (e.g. long or slow acting insulin), strips for blood glucose testing (to be used in connection with blood glucose meters as known in the art, needles for a syringe, a doser or for an additional drug administration device, the additional drug administration device itself, pens and pre-filled pens. The problem worsens if the patient is an area where shopping possibilities are limited.

Thus the prior art systems have the disadvantages that they do not provide secure, reliable and fast measures to improve the therapy in the form of an advice which is at least confirmed or modified by a physician, neither does the prior art system help the patient in stock management of items needed for treatment of diabetes.

Said disadvantages are overcome, and said problems are solved according to the invention when a method is provided, which comprises the steps of:
subscribing with an identification code of a drug administration device to a health care advisory system,
transferring the identification code of the drug administration device to the health care advisory system,
controlling that the patient having the drug administration device is a subscriber to the health care advisory system based on the received identification code,
requesting and receiving treatment data from the subscribing drug administration device,
generating an advice based on the received treatment data and a personalized setup of patient related data in the health care advisory system, the advice being optionally verified or modified by a health care person, and/or generating an order based on the received treatment data in the health care advisory system to supply goods to the patient, and
sending the advice to the drug administration device, and/or sending the order to a goods supplier.

In a preferred embodiment the method further comprises the step of:
charging the patient having the drug administration device for the received service, i.e. advice and/or order), i.e. for the advice received and/or for the order sent to the goods supplier.

It is an advantage of the present invention that unusual situations can be handled by an apparently stand alone device, i.e. the drug administration device, since it is provided with an advice that involved a skilled person in treatment of diabetes, e.g. a nurse, a physician, or another healthcare person. This is the case since a skilled person in treatment of diabetes is required to look on the recent treatment data pattern to provide a trustworthy advice to the patient for the more complicated situations. Or, at least, the advice provided by the health care advisory system to the drug administration device can be verified by a health care person prior to sending that advice to the drug administration device.

Furthermore, it is an advantage according to the present invention when the patient is away from his hospital and/or is remote to his nurse, physician or other healthcare persons; it is easy for him to know what to do since he receives an advice on his drug administration device in any situation.

Moreover, it is an advantage according to the present invention that situations—when the patient is about to run out of aiding items for the treatment of his diabetes—are properly handled. When the patient is about to run out of e.g. insulin cartridges of different concentrations, i.e. long or slow acting insulin, or strips for blood glucose testing, needles, or for a syringe, or for a doser, etc, the health care advisory system will due to knowledge of the stock situation (of insulin cartridges, strips, syringes, dosers belonging to the patient) well before generate an order for the missing item(s) and subsequently send the order to a supplier of the item(s) or goods.

It is an advantage of the invention that the method, the drug administration device and the system, respectively provides a service to the patient. The service can be an advice having the advantage of being secure, reliable and fast advices, thus the therapy is thereby improved and more trustworthy for the patient.

The advice is secure since it is generated in a health care advisory system, since skilled person, e.g. a nurse, a physician or other healthcare persons knowing the patient and his related treatment data and past treatment pattern is involved in the advice generating process, i.e. the advice is thought out by the skilled person or is at least confirmed by that person. Since the patient knows that said skilled persons are involved, the advice is perceived trustworthy for the patient.

Accordingly, the patient using the drug administration device and subscribing to the services (advices) of the health care advisory system will consider the received advices to be reliable and trustworthy.

Moreover, the advices can be provided fast and in real time since the drug administration device can communicate treatment data and the health care advisory system can respond with advice(s), when needed 24 hours a day. This may be part of the subscription deal, i.e. a provider of the health care advisory system may guaranty 100% online services 24 hours a day. The price and quality of advices may depend on which subscription chosen; a gold member will be charged more for the advice than a silver member subscriber.

Further more, the service can be to issue an order to supply goods, e.g. insulin cartridges, pens, needles, test strips, etc. to the patient.

As a further aspect of the invention, the user is charged accordingly for received service. Since he is charged, he can be free for popping up ads, and further he will only receive an advice when needed. The user will not be bothered with advertising information and spam mails since the drug administration device and the health care advisory system can establish a direct communication link not allowing other devices to intrude with unwanted information. This is an advantage, since the user knows he has to pay, and thus he will observe that a high quality and trustworthy communication link and services are provided just because he pays for them. It is well known that for free services advertising information and spam mails are part of the information received and are irritating and that response time and quality can be very varying and thus very annoying.

Furthermore, since he is either a subscriber of the system or is using the drug administration device and the healthcare advisory system branded by the same company, he only has to address any technical problem(s) to the one and same company, i.e. the one branding the service or the company to which he has subscribed to the service.

As discussed, the invention may be carried on a drug administration device, it may be a doser for injection of insulin in various concentrations, it may be in a simpler form as a syringe equipped with display capabilities. For example U.S. Pat. No. 6,540,672, WO0032258, WO0191833 and WO2003005891 each of these discloses intelligent drug administration devices, (which are hereby incorporated by reference in its entirety).

The invention may as well be carried on a drug administration device in form of a pump also capable of infusing insulin in various concentrations as general known in the art; in that case the advice could be converted to infusion of insulin in the proper amount and concentration.

Alternatively, the drug administration device may be an inhalation device: various inhalation devices exist that aid in depositing a liquid aerosol or dry aerosol powder into a patient's lungs. For example, U.S. Pat. No. 5,888,477 (which is hereby incorporated by reference in its entirety) discloses an inhaler with robust features that may be used for insulin delivery. U.S. Pat. No. 5,785,049 to Smith et al. (which is hereby incorporated by reference in its entirety) discloses a device suitable for powdered medication delivery.

Thus, in the present context, the term ‘drug administration device’ is taken to mean, an injector type device (such as a pen injector or a jet injector) for delivering a discrete dose of a liquid medication (possibly in the form of small drops), a medication pump for continuous delivery of a liquid medication, an inhaler, spray or the like for delivering a discrete or continuous dose of a medication in vaporized, ‘atomized’ or pulverized form.

The invention will be explained more fully below in connection with preferred embodiments and with reference to the drawings, in which:

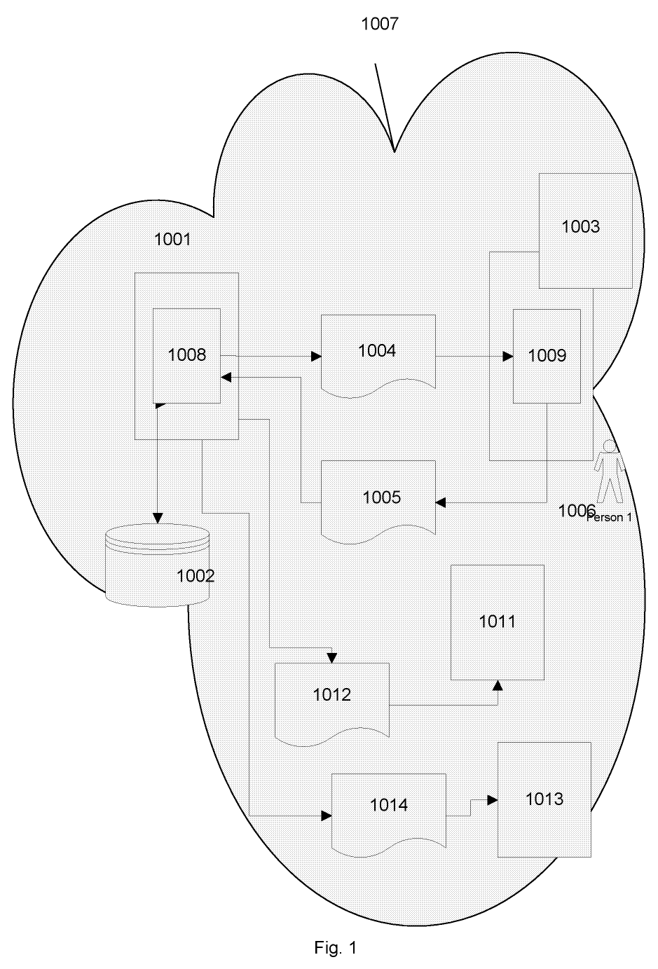

FIG. 1 shows a system with a health care advisory system, drug administration devices, a user and the flow of information in the system,

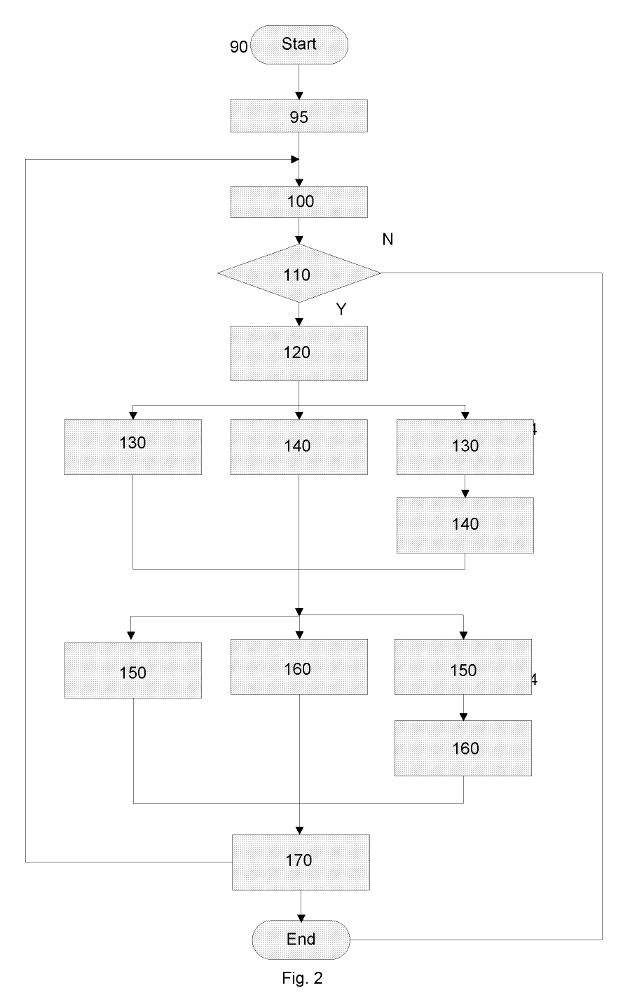

FIG. 2 shows a method of giving a service to a patient,

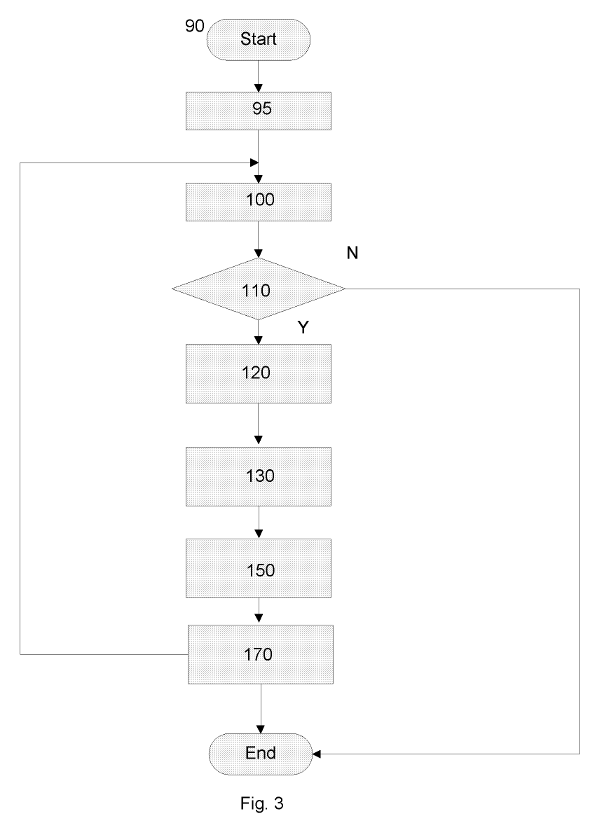

FIG. 3 shows the method of giving a service to a patient, in an exemplary embodiment where the service is to provide an advice, and

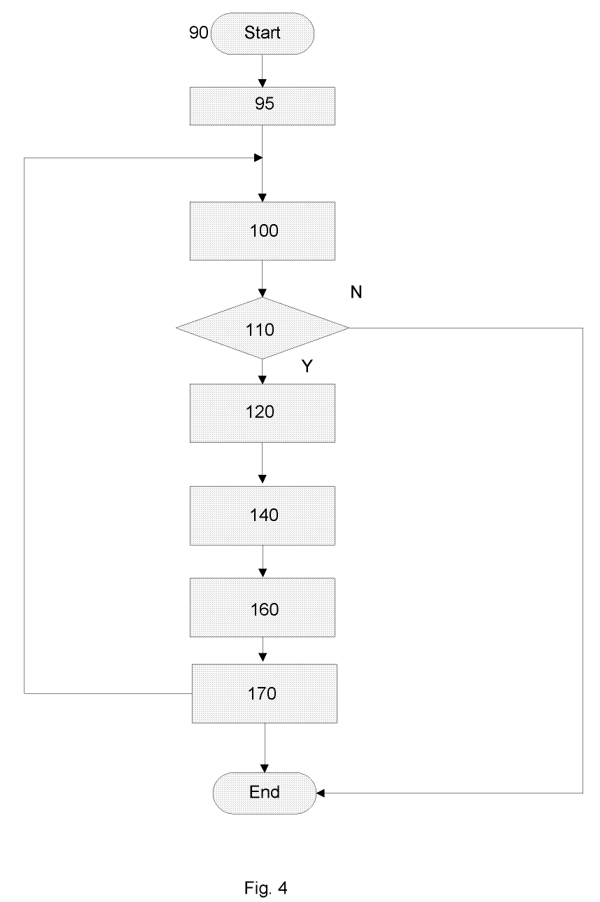

FIG. 4 shows the method of giving a service to a patient, in an exemplary embodiment where the service is to generate and send an order.

In a preferred embodiment of the invention, the method of the invention (FIGS. 2, 3 and 4) is executed on a drug administration device communicating with the health care advisory system, this is explained in the following in FIG. 1 showing a system with the health care advisory system, the drug administration device(s), a user and a flow of information in the system.

Reference numeral 1001 may be a health care advisory system. The health care advisory system is mainly the controlling part of the system. It may be implemented on one or more servers as known in the field of computing. The health care advisory system may be accessed by various drug administration devices as shown by reference numeral 1003. These may seen as counter parts to said server(s)be and may thus be regarded and implemented as more clients as also known in the field of computer science. The health care advisory system (server) comprises means for connection to the Internet with a possibility to be accessed simultaneously by various drug administration devices (clients) using the services provided by said health care advisory system. Said services are discussed in the methods of FIGS. 2, 3 and 4.

The health care advisory system may have a connection to a database, which is shown by reference numeral 1002. The database may comprise information about each drug administration device and its corresponding treatment data, the treatment data in the database thus is a collection of blood glucose data, insulin intakes, meal and exercise, respectively with their time stamps transferred from the memory of the drug administration device to said database. These data can then in the data base be summarized to the individual user's diary data, and may e.g. be referred to later by means of the unique identification code belonging to the drug administration device, which in fact provided these data. Each time new data is received, the database accordingly will be updated.

Furthermore, the health care advisory systems' database comprises a personalized setup of patient related data. These data are discussed in the method.

On the basis of these data, the health care advisory system can provide various services, basically it will provide an advice to the user of the drug administration device and help the same user of the drug administration device of managing his stock of diabetes medication items, these can be insulin cartridges, strips for blood glucose testing, needles, an additional drug administration device, pens and pre-filled pens. As an example the patient may have various insulin cartridges, e.g. some for long acting insulin, others for slow acting insulin, and may be also some for mixed insulin types. Especially, when the health care advisory system is aware of the patients various insulin intakes (long acting, slow acting insulin and mixed insulin types), it can easily compute when the user is running out of stock and then as a service send a corresponding order (1012) to a goods supplier (1011), which then can supply directly the missing medication items to address of the owner and user of the drug administration device. Correspondingly, when the health care advisory system is aware of the patients'number of blood glucose tests, it can easily compute when the user is running out of test strips, since per glucose test one single test strip is used and thrown away. Corresponding considerations applies for stock management of needles, e.g. when the health care advisory system is aware of the patients' number of injections, it can easily compute when the user is running out of needles since one needle is used per injection. In order to issue an order for an additional drug administration device, pen(s) or for pre-filled pen(s), the health care advisory system can use the number of injections to know when such devices are to be replaced in due time, for example by counting the number of injections performed on the device, it can be estimated when critical components, e.g. push buttons, mechanics are likely to malfunction in the future, for this reason it can be advisable to replace the device and order a new one a said goods supplier.

As discussed, the health care advisory system provides two services: stock management and advices to the user of the drug administration device. The health care advisory systems' database comprises information about each drug administration device and its corresponding treatment data, thus the treatment data is a complete compilation of blood glucose data, insulin intakes, meals consumed and exercises performed, respectively with their time stamps. These data are in the data base summarized to the individual user's diary data, and is referred to by means of the unique identification code belonging to the drug administration device. With this complete overview of the users past habits as regards performed blood glucose tests (using a test strip as a diabetic medication item each time), performed glucose regulating actions, such as intake of insulin in various concentrations in various forms e.g. by injections and/or pulmonary intake or even by means of intake of Glucagon, each of these can be counted when applied and accordingly, it is possible to have an assessment of the stock situation for each diabetic medication item. The stock situation can be computed as initial stock of a specific diabetic medication item minus no of. diabetic medication item(s) applied. As an example, the user initially purchased 100 test strips, 85 times he performed a glucose measurement (each time using a test strip), thus the current stock situation for test strips is then 100 minus 85, i.e. 15 test strips are remaining. Assuming that the criterion for generating an order is a computed stock situation for test strips below 20 test strips, the order, e.g. for 1000 new test strips, should be generated to secure that the patient does not run out of test strips in the next coming few days assuming that he tests his blood glucose level four to five times a day, each time using a test strip.

Based on the number of injections performed by drug administration device—and exceeding a certain upper limit of injections—an order could be generated to swap this device, since there could be a risk of malfunctioning due to wear of the injection mechanism. When swapped, the number of injections performed by the new drug administration device initially is set to zero.

In addition to complete the overview of the users past habits, the health care advisory system also comprises information about performed exercise(s), which food(s) and/or beverage(s) consumed at corresponding time stamps. By means of the complete compilation of blood glucose data, insulin intakes, meals and exercises with time stamps, the health care advisory system can provide the patient with an advice what to do and when: such an advice can be any of the following: performing blood glucose testing, visit a physician for a health check, visit a physician for a conversation, perform some kind of a glucose regulating action such as intake insulin in the preferred formulation, e.g. take a tablet, perform an injection of insulin or in a pulmonary form, alternatively the advice could be to intake Glucagon or perform an exercise of a certain duration, eat or drink in a proposed number of carbohydrates. Moreover, the advice could be to supply the user with information materials, e.g. a text, a movie explaining how to inject, how to apply and to use a test strip, how manually to enter relevant data, etc. The advice can be computed by a computer being a part of the health care advisory system and provided as it is, or the advice has to be confirmed or to be modified by a health care person. These alternatives are discussed in the method.

Reference numeral 1003 may be the drug administration device. The drug administration device may be used as the connection point to a user (owner or patient), reference numeral 1006, using the methods of FIGS. 2, 3 and 4. There may be more drug administration devices simultaneously accessing the health care advisory system via the Internet or any other open network, reference numeral 1007. The various drug administration devices are designated by the two rectangles of reference numeral 1003.

The reference numeral 1005 may generally be treatment data relating to the patient and user of the drug administration device, further it can when needed comprise an identification code of the drug administration device.

The reference numeral 1004 may generally be information sent in the opposite direction of the method as a response to the information contained in reference numeral 1005. Reference numeral 1004 may generally represent information of the method sent from the health care advisory system to the drug administration device by means of reference numeral 1007. The said information may comprise various advices as discussed above, these may be send in the form of a simple text, a picture, a movie and or a drawing in known downloadable file format.

Reference numeral 1007 may be an open network. The network may be the Internet or any other hard- or non hard-wired connection known to enable communication between drug administration devices and a health care advisory system.

Reference numeral 1008 may be a processor of the health care advisory system. It may be used as discussed to compute advices and orders and to receive treatment data along with the identification code.

Further, the processors' 1008 computed orders 1012 are to be transferred to good supplier 1011, and in order to handle the payment and charging or a transfer of what to pay for (diabetes medication item(s)) and in which amount 1014, including advices given has to be sent to a banking system, credit card issuer, bank, credit card institute etc, these latter possibilities are as shown by means of reference numeral 1013.

Reference numeral 1009 may be a processor of the drug administration device. Said processor may be used to collect and transfer said treatment data and its own the identification code identifying this particular administration device to the health care advisory system. Some treatment data, e.g. blood glucose reading may be received from an external glucose meter or may be entered to the device from a test-strip. Other treatment data may be automatically captured by the device, e.g. when in which amount a certain concentration type of insulin was provided to the patient.

Said transfer of data, e.g. advices, orders and the charging may be performed by means of transmission means, a network, e.g. a local area network (LAN), a wide area network (WAN), or any combination thereof, e.g. the Internet, an intranet, an extranet, or an on-line service. Alternatively, the transfer of data may be performed by means of IrDA, a Bluetooth communications standard or any other way as known in the art to transfer data wirelessly between two devices, e.g. a wireless drug administration device adapter, a wireless LAN adapter, etc. The wireless transfer may be implemented following a medical communication standard such as MICS, Medical Implant Communications Services or WMTS, i.e. the Wireless Medical Telemetry Service. The transfer of data may be encrypted, and the receiver may then decrypt the data accordingly, this applies for the drug administration device and for the health care advisory system, which both may switch between sender and receiver of data.

FIG. 2 shows a method of giving a service to a patient. In step 90, the method is started with initialization of variables and counters at the drug administration device and the health care advisory system, respectively.

In step 95, the user can subscribe with an identification code belonging to the drug administration device to the health care advisory system. The user may subscribe to various services, e.g. subscribe to only receive an advice or subscribe only to have his stock of medication items handled, i.e. for the latter make a subscription such that only an order can be issued for missing or near to missing one or more diabetes medication items to corresponding goods supplier(s).

Alternatively, the user can subscribe to more services, i.e. he can choose to subscribe in order to be able to receive an advice and to have his stock of medication items supervised.

Alternatively, the user can subscribe to different levels of services, a gold member subscriber will be provided with advices with the highest involvement of health care personal and will be charged more for his received advices than the silver member.

Further the user may choose to have only certain advices provided to him, e.g. the user can choose to select one or more of the following advice types as one or more subscribed to service(s):

“Please perform blood glucose testing”, “Please visit a physician for a health check”, “Please visit a physician for a conversation”, “Please perform a glucose regulating action, e.g. intake insulin for example by means of an injection and/ or as a pulmonary intake, “Please intake Glucagon,”

“Please do an exercise”, “Please take of some food”, and “Please drink something”. The way of generating these will be discussed in step 130.

In step 100 the identification code of the drug administration device may be transferred to the health care advisory system. The drug administration device is the identification of the user and also identifies—as discussed above—which certain advice types subscribed to, i.e. which advices the user as the patient wants to use. The device contains a unique identification code that will identify the user and ensure secure communication, e.g. using encryption. Accordingly, in that case data is to be decrypted at the health care advisory system.

In step 110, the health care advisory system controls that the patient having the drug administration device is in fact a subscriber to the health care advisory system, said control is based on the received identification code. For example the received identification code can be verified against subscribing identification codes as were discussed in step 95. The subscribing identification codes may at the time of subscription have been stored in the database as was denoted 1002 in the health care advisory system.

The identification code is a unique identification code; in step 100 identification codes are thus received by the health care advisory system, and these codes are from the corresponding users of the drug administration devices. A check routine is performed for each received identification code, thus making it possible for the health care advisory system to secure that the recipient of the subscribed service(s) is the authentic subscriber, i.e. the subscribing drug administration device.

When the check routine confirms that the drug administration device is a subscribing drug administration device, the steps as follows are executed, i.e. steps 120, 130, 140, 150, 160 and 170.

Conversely, i.e. in case the check routine cannot confirm that the drug administration device is a subscribing drug administration device, the method goes to an end and no further steps are executed. However, when the health care advisory system receives any identification code of any drug administration device—as discussed in step 100—the check routine in step 110 will be executed again, it may be the case that the user in the mean time subscribed to service(s) in step 95, and consequently the check routine will confirm now that this specific drug administration device is now a new subscribing drug administration device.

In case the check routine confirmed that the drug administration device was a subscribing drug administration device, the method will perform the next steps.

In step 120, the health care advisory system will request and then receive treatment data from the subscribing drug administration device. As a response to the request, the subscribing drug administration device sends treatment data. The treatment data comprises blood glucose data, insulin intakes, meal and exercise, respectively with their time stamps, treatment data may be retrieved from the memory of the drug administration device.

Step 120 can be repeated until the health care advisory system has a complete picture of a treatment. The health care advisory system will—with the time stamps relating to the treatment data—be able to know whether it is a complete picture, and if not request further treatment data from missing periods, i.e. from certain intervals of time stamps.

In all cases, the drug administration device will transfer all necessary treatment data to the health care advisory system as an example of a service provider. The data could also contain requests for other services, e.g. a advice based on the data from the device, or the health care advisory system will itself based on the received treatment data find it appropriate and relevant to come up with an advice, see step 130 for the advice.

In step 130, the health care advisory system or the service provider generates an advice as the service. The advice is computed based on the received treatment data and a personalized setup of patient related data in the health care advisory system, the advice can be kept as it is, or the advice is either verified or modified by a health care person, i.e. a skilled health care personal, e.g. a nurse, or a physician knowing the patients past and current treatment situation and also knowing the personalized setup of patient related data. By means of the complete compilation of blood glucose data, insulin intakes, meals and exercises with time stamps, the health care advisory system can provide the patient with an advice what to do and when: such an advice can be any of the following: performing blood glucose testing, visit a physician for a health check, visit a physician for a conversation, perform some kind of a glucose regulating action such as intake insulin in the preferred formulation, e.g. take a tablet, perform an injection of insulin or in a pulmonary form, alternatively the advice could be to intake Glucagon or perform an exercise of a certain duration, eat or drink in a proposed number of carbohydrates. Moreover, the advice could be to supply the user with information materials, e.g. a text, a movie explaining how to inject, how to apply and to use a test strip, how manually to enter relevant data, etc. E.g. if the glucose level is too high the health care advisory system can generate the advice as the proper amount of insulin to intake for the patient, in which form e.g. a tablet, by means of an injection of insulin (long or slow acting). E.g. if the glucose level is too low the health care advisory system can generate the advice as the proper amount of food or beverage to consume, what kind of food, e.g. in number of carbohydrates. E.g. if the glucose level is excessive low the health care advisory system can generate the advice to inject Glucagon.

The health care advisory system has access to a complete compilation of automatically registered data for blood glucose data and insulin intakes and manually entered meals and exercise data with time stamps. As an initialization of the health care advisory system, the physician or nurse, etc performed a personalized setup of patient related data with the health care advisory system: said of patient related data could e.g. be treatment regime, min, max and target values for the blood glucose, number of glucose measurements per day, and target weight.

For more advanced advices other parameters could be set up in the advisory system as an addition to said personalized setup of the patient related data, the other parameters could be e.g. insulin sensitivity, glucose to insulin ratio, carbohydrate to insulin ratio, as well as laboratory data such as HbA1c, and the patient may provide other relevant parameters as a further initialization of the patient related data to the health care advisory system, e.g. sickness/fever/vomiting, mental state, alcohol and/or smoking habits—both types of parameters which will enable the health care advisory system provide more specific, accurate and reliable personalized advices.

This personalized setup and initialization, i.e. the patient related data together with factory settings provide the boundary conditions in a diabetes-treatment state space. The state of the patient together with the time of day will always be described by one point in this diabetes-treatment state space. A data point is either in a desired area or in an undesired area, for instance—as an example of a data point—the blood glucose is either within the min-max range or outside, either the most recent blood glucose testing is sufficiently new, or it is too old. If the state is undesired an advice is generated for how to get back into the desired area. The advice is selected by looking at how the user left the desired area or the least distance to get back into the desired area. The health care advisory system could be a learning-based advisory system; in that case the advice is based on successful advices given in similar situations or to similar patients in the same or similar situation. Alternatively or additionally, the health care advisory system could be a model based advisory systems, where the advice is based on physiological simulation of the consequences of following the advice, i.e. simulations of all possible advices are carried out and the advice which is simplest to follow and has the most desired consequence is subsequently (in step 150) sent to the user of the drug administration device.

As discussed, the generated advice can:
1) be kept as it is from the health care advisory system, in that case the advice is so simple that a computer alone could be relied on to be allowed to compute the advice, or
2) be subsequently verified by a health care person, or
3) be subsequently modified by a health care person,
   i.e. the skilled health care person is e.g. a nurse, or a physician knowing the patients past and current treatment situation and also knowing the personalized setup of the patient related data.

Thus, the advice that is generated from the health care advisory system can come through three different channels:

Case 1: Most basic advices will be generated directly from the service providers' computer system, i.e. the health care advisory system and is subsequently sent as it is to the patient having the drug administration device. The advice could be a simple request from the health care advisory system to the patient like to “test glucose”, “Update diary”, “input meals data”, “input exercise data” or other simple input of treatment data, e.g. if data haven't been keyed in the last 16 hours, data apparently is missing in the drug administration device. An advantage for case 1 is that no health care personal need be involved in this simple advice generation.

Case 2: More advanced or serious advices will be generated by the computer and relayed through a physician, a call centre, nurses or similar—onto the patient. These advices could be: take insulin, change dose etc. As compared to advices in case 1, the advices—when followed—in case 2 have more impact on the patients' condition and therefore have to be verified by a health care person.

Case 3: Even more serious advices can be directed to a specialist of choice, and can result in that a contact directly from the specialist to the patient is the advice. As compared to advices in case 2, the advices in case 3 have even more impact on the patients' condition and therefore have to be modified by a health care person.

The system can provide information and advises based on the information received from the device. The patient can subscribe to several levels of advices, by signing up to these services e.g. gold members, silver members, etc. The differences in the services provided could be:

It could be agreed in the subscription that the gold member will always be contacted directly by a specialist in diabetes treatment; the member can set up multiple reminders that comes from the provider, like take exercise etc.

Consequently, a gold member will be charged more for the advice that the silver member, etc. Correspondingly, advices in case 3 are more expensive than advices in case 2, correspondingly, the advices generated and confirmed in case 2 are more expensive than the more simple advices in case 1.

The service provider or the health care advisory system may choose to distribute its job to other cooperating service providers, however the user of the drug administration device will not experience that others are involved.

As an alternative or in addition to step 130, step 140 may be executed.

In step 140, an order is generated as the service. The order is based on the received treatment data in the health care advisory system, the order is to supply goods to the patient, and the order is transferred to a goods supplier. Thus, the service could also be a material transaction, where the drug administration device—alternatively by means of or via the health care provider—orders more diabetic item supplies e.g. insulin, needles, swaps, glucose test materials and/or information materials. The drug administration device or the health care advisory system will know the status on the patients inventory, and will know the actual usage of supplies, and will therefore be able to automate the order, said order comprises one or more of the following goods or diabetes medication items: insulin cartridges, strips for blood glucose testing, needles, an additional drug administration device, swaps, pens and pre-filled pens.

As a result of step 130, i.e. the generated advice; in step 150 this advice is send to the drug administration device, step 150 is only executed when step 130 was executed. It is the assumed since a proper communication already was in place that the drug administration device receives the advice.

In addition or as an alternative to step 150, when the advice or service have been generated by the service provider, the advice will be send to the drug administration device as a notification or as information through the internet. In any case, the specific advice reaches the drug administration device.

Said advice (1004) comprises one or more of the following: performing blood glucose testing, visit a physician for a health check and/or a conversation, perform a glucose regulating action, such as intake insulin (inject, pulmonary, etc), intake Glucagon, performing an exercise, in taking of food and/or a beverage and/or information materials.

As a result of step 140, i.e. the generated order; in step 160 this order is send to a goods supplier, step 160 is only executed when step 140 was executed.

As an alternative or in addition to step 150, if the generated service is a supply or a purchase order, in step 160 the service provider will generate an order that will be transmitted through the service providers network, directly to the supplier who will execute the order.

In step 170, the patient having the drug administration device is charged for the received service. The service is one of advice, order or both.

The charging can be performed in various was, in the art it is known to pay for online content/service with the product delivered via the internet:
http://www.apple.com/itunes/ (Download of individual music tracks)
http://www.amazon.com/exec/obidos/tg/browse/-/551440/ref=b tn bh eb/102-3780996-4184138 (eBooks)
http://www.macromedia.com/downloads/ (Software downloads)
http://www.movieflix.com/ (Movie pay for view)

However, according to the present invention the product, the physical goods) will be delivered by ordinary mail, i.e. via a postal service e.g. via DHL, UPS, etc. but charging for the service could be performed as discussed above; the advice can be considered as online content via the internet, if not transmitted direct from the health care advisory system.

Also known in the art as a way of charging like online stock brokers (www.etrade.com ) may be applied, where payment is usually a fixed fee per transaction.

eBays' PayPal is another alternative for charging for the service provided. Further, from Denmark “valus” and CoinClick are known as a way for charging for the service. Alternatively, an agreement could be made with a bank or a credit card institute allowing the health care advisory system and the goods supplier to withdraw money from the patients' account, when a service is used and/or when a diabetic medication item has been ordered.

Alternatively, as a way for charging for the service, the charging can be optimized for use for low value transfers between parties who have a relationship over a period of time. Thus it provides a higher degree of protection against fraud making it applicable in wider scenarios, including sale of tangible goods, e.g. diabetic medication items.

Finally, models are evolving bearing the name of micro-payment; these could as well be applied for the charging of services as discussed in step 170.

FIG. 3 shows the method of giving a service to a patient as discussed in FIG. 2, in an exemplary embodiment where the service is only to provide an advice, i.e. step 130 where the advice is generated and step 150 where the advice is send to the drug administration device. In this case, the method is performed where there was no need to generate an order since no diabetic medication item(s) could be computed to be in risk of being missing at the patient, accordingly steps 140 and 160 are omitted as compared to FIG. 2. The explanatory text for the steps common to FIGS. 2 and 3 remains the same.

FIG. 4 shows the method of giving a service to a patient as discussed in FIG. 2, in an exemplary embodiment where the service solely is stock management, i.e. to generate, i.e. step 140 and subsequently to send an order the goods supplier as indicated in step 160. In this particular case the method is performed where there was no need to generate an advice, e.g. the advice was not computed to be in need or the advice had just been given, accordingly steps 130 and 150 are omitted as compared to FIG. 2. The explanatory text for the steps common to FIGS. 2 and 4 remains the same.

A computer readable storage medium may be a magnetic tape, an optical disc, a digital video disk (DVD), a compact disc (CD or CD-ROM), a mini-disc, a hard disk, a floppy disk, a smart card, a PCMCIA card, a ram stick, etc. or any other kind of media that provides a computer system with information regarding how instructions/commands should be executed.

All references, including publications, patent applications, and patents, cited herein are hereby incorporated by reference to the same extent as if each reference were individually and specifically indicated to be incorporated by reference and were set forth in its entirety herein.

Any combination of the above-described elements in all possible variations thereof is encompassed by the invention unless otherwise indicated herein or otherwise clearly contradicted by context.

The use of the terms “a” and “an” and “the” and similar referents in the context of describing the invention are to be construed to cover both the singular and the plural, unless otherwise indicated herein or clearly contradicted by context.

Recitation of ranges of values herein are merely intended to serve as a shorthand method of referring individually to each separate value falling within the range, unless otherwise indicated herein, and each separate value is incorporated into the specification as if it were individually recited herein. Unless otherwise stated, all exact values provided herein are representative of corresponding approximate values (e.g., all exact exemplary values provided with respect to a particular factor or measurement can be considered to also provide a corresponding approximate measurement, modified by “about,” where appropriate).

All methods described herein can be performed in any suitable order unless otherwise indicated herein or otherwise clearly contradicted by context.

The use of any and all examples, or exemplary language (e.g., “such as”) provided herein, is intended merely to better illuminate the invention and does not pose a limitation on the scope of the invention unless otherwise indicated. No language in the specification should be construed as indicating any element is essential to the practice of the invention unless as much is explicitly stated.

The citation and incorporation of patent documents herein is done for convenience only and does not reflect any view of the validity, patentability, and/or enforceability of such patent documents.

The description herein of any aspect or embodiment of the invention using terms such as “comprising”, “having,” “including,” or “containing” with reference to an element or elements is intended to provide support for a similar aspect or embodiment of the invention that “consists of”, “consists essentially of”, or “substantially comprises” that particular element or elements, unless otherwise stated or clearly contradicted by context (e.g., a composition described herein as comprising a particular element should be understood as also describing a composition consisting of that element, unless otherwise stated or clearly contradicted by context). This invention includes all modifications and equivalents of the subject matter recited in the aspects presented herein to the maximum extent permitted by applicable law.

1. A method of giving a service (1004, 1012) to a patient (1006), said method comprising the steps of:
subscribing (95) with an identification code of a drug administration device (1003) to a health care advisory system (1001),
transferring (100) the identification code of the drug administration device (1003) to the health care advisory system (1001),
controlling (110) that the patient having the drug administration device (1003) is a subscriber to the health care advisory system (1001) based on the received identification code,
requesting (120) and receiving treatment data from the subscribing drug administration device (1003),
generating (130) an advice (1004) based on the received treatment data and a personalized setup of patient related data in the health care advisory system, the advice being optionally verified or modified by a health care person, and/or generating (140) an order (1012) based on the received treatment data in the health care advisory system to supply goods to the patient, and
sending (150) the advice (1004) to the drug administration device (1003), and/or sending (160) the order (1012) to a goods supplier (1011).

2. A method according to claim 1, said method further comprising the step of:
charging (170) the patient (1006) having the drug administration device (1003) for the received service.

3. A method according to claim 1, wherein step 120 is repeated until the health care advisory system has a complete picture of a treatment.

4. A method according to claim 1, wherein said advice (1004) comprises one or more of the following:
performing blood glucose testing, visit a physician for a health check and/or a conversation, perform a glucose regulating action, such as intake insulin, intake Glucagon, performing an exercise, in taking of food and/or a beverage, information materials, update diary, input meals data and input exercise data.

5. A method according to claim 1, wherein said order (1012) comprises one or more of the following goods:
diabetes medication items, such as insulin cartridges, strips for blood glucose testing, needles and an additional drug administration device.

6. A drug administration device (1003) comprising
means for subscribing (95) with an identification code to a health care advisory system (1001),
means for transferring (100) the identification code to the health care advisory system (1001),
means for sending treatment data (1003) upon request to the health care advisory system (1001), and
means for receiving (130) an advice (1004) based on the received treatment data and a personalized setup of patient related data from the health care advisory system, the advice being optionally verified or modified by a health care person.

7. A system comprising a health care advisory system (1001) and a drug administration device (1003), said system comprising:
means for subscribing (95) with an identification code of the drug administration device (1003) to the health care advisory system (1001),
means for transferring (100) the identification code of the drug administration device (1003) to the health care advisory system (1001),
means for controlling (110) that the patient having the drug administration device (1003) is a subscriber to the health care advisory system (1001), said means for controlling is based on the received identification code,
means for requesting (120) and means for receiving treatment data from the subscribing drug administration device (1003),
means for generating (130) an advice (1004) based on the received treatment data and a personalized setup of patient related data in the health care advisory system, the advice being optionally verified or modified by a health care person,
means for generating (140) an order (1012) in the health care advisory system to supply goods to the patient, said means for generating (140) an order (1012) is based on the received treatment data,
means for sending (150) the advice (1004) to the drug administration device (1003), and
means for sending (160) the order (1012) to a goods supplier (1011).

8. A system according to claim 7, said system further comprising:
means for charging (170) the patient (1006) having the drug administration device (1003) for the received service.

9. A computer program product comprising program code means stored on a computer readable medium for performing the method claim 1, when the computer program is run on a computer.
